(19) United States
(12) Patent Application Publication
(10) Pub. No.: US 2010/0263125 A1
(43) Pub. Date: Oct. 21, 2010

(54) EMBEDDED HEADREST ASSEMBLY FOR A MASSAGE TABLE

(76) Inventors: Jonathan W. Roleder, San Diego, CA (US); Richard V. Estrada, Oceanside, CA (US); William W. Chow, Del Mar, CA (US); Oscar Mendez, Temecula, CA (US)

Correspondence Address: Roeder & Broder LLP, 5560 Chelsea Avenue, La Jolla, CA, 92037, US

(21) Appl. No.: 12/580,086

(22) Filed: Oct. 15, 2009

Related U.S. Application Data
(60) Provisional application No. 61/105,892, filed on Oct. 16, 2008.

(51) Int. Cl. A61G 13/12

(52) U.S. Cl. 5/622

(57) ABSTRACT

A massage table (210) for supporting a person above a surface (16) during a massage includes a table top assembly (212) and a headrest assembly (224). The table top assembly (212) includes a table aperture (212A) and the headrest assembly (224) is positioned substantially within the table aperture (212A). The headrest assembly (224) can include a headrest (232) that supports a head (25B) of the person during the massage and a coupler assembly (234) that couples the headrest (232) to the table top assembly (212). The headrest (232) includes a support frame (236) and a resilient assembly (238). The resilient assembly (238) is positioned substantially above the support frame (236) and is supported by the support frame (236). The support frame (236) and the resilient assembly (238) cooperate to adjustably support the head (25B) of the person during the massage. The coupler assembly (234) includes an adjuster assembly (250) that selectively adjusts the height and angle of the headrest (232) relative to the table top assembly (212). The coupler assembly (234) further includes a bracket assembly (252) that couples the adjuster assembly (250) to the table top assembly (212).

### RELATED APPLICATION

This Application claims the benefit and priority on U.S. Provisional Application Ser. No. 61/105,892 filed on Oct. 16, 2008. The contents of U.S. Provisional Application Ser. No. 61/105,892 are incorporated herein by reference.

### BACKGROUND

As the benefits of therapeutic massage are becoming more widely appreciated, more and more people are participating in therapeutic massage. A typical massage table allows the patient to be resting while receiving a massage. A massage table includes a headrest that supports the head of the patient during a massage. Important features for massage devices include high strength, ease of use, adjustability, light weight, and comfort.

### SUMMARY

The present invention is directed to a massage table for supporting a person above a surface during a massage. In certain embodiments, the massage table comprises a table top assembly and a headrest assembly. The table top assembly includes a table aperture and the headrest assembly is positioned substantially within the table aperture. In some embodiments, the headrest assembly includes a headrest that supports a head of the person during the massage and a coupler assembly that couples the headrest to the table top assembly.

As an overview, in certain embodiments, the headrest assembly provides improved comfort, adjustability, and support to the face and/or the head of the user of the massage table. Moreover, the headrest assembly can have a relatively low profile and can curve to better “wrap”, “envelop” and/or “cradle” the face and/or the head of the user of the massage table.

In some embodiments, the headrest includes a support frame and a resilient assembly. The resilient assembly is positioned substantially above the support frame and is supported by the support frame. In one such embodiment, the support frame and the resilient assembly cooperate to adjustably support the head of the person during the massage.

In one embodiment, the coupler assembly includes an adjuster assembly that selectively adjusts the height and angle of the headrest relative to the table top assembly. In this embodiment, the coupler assembly also includes a bracket assembly that couples the adjuster assembly to the table top assembly. In some embodiments, the bracket assembly can include a first bracket that is secured to the table top assembly and a spaced apart second bracket that is secured to the table top assembly. Each of the brackets is coupled to the headrest. The brackets cooperate to couple the headrest to the table top assembly.

In certain embodiments, the headrest can further include an upper pad that is positioned substantially above the resilient assembly and is supported by the resilient assembly.

In one embodiment, the resilient assembly includes an upper resilient member and a headrest platform that supports the upper resilient member. In this embodiment, the headrest platform has a first side section, a second side section, a middle section, and a hinge assembly. The middle section is positioned substantially between and is coupled to the first side section and the second side section. The hinge assembly allows the middle section to flex downward and the side sections to pivot upward and inward toward each other when downward pressure is applied on the middle section.

In another embodiment, the resilient assembly includes a first resilient subassembly and a second resilient subassembly. The first resilient subassembly is coupled to the support frame. The second resilient subassembly engages the first resilient subassembly. In this embodiment, the first resilient subassembly and the second resilient subassembly cooperate to support the head of the person during the massage. In one such embodiment, the first resilient subassembly includes a resilient member that extends away from the support frame and the second resilient subassembly engages the resilient member.

The present invention is further directed to a method for supporting a person above a surface during a massage.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified side view of a first embodiment of a massage table having features of the present invention;

FIG. 2A is a top perspective view of another embodiment of a massage table having features of the present invention;

FIG. 2B is a top, partly exploded perspective view of the massage table of FIG. 2A;

FIG. 2C is a top view of a portion of the massage table of FIG. 2A;

FIG. 2D is a side view of a portion of the massage table of FIG. 2A;

FIG. 2E is an end view of a portion of the massage table of FIG. 2A;

FIG. 2F is side view of a portion of the massage table of FIG. 2A in partial cut-away;

FIG. 2G is side view of a portion of the massage table of FIG. 2A in partial cut-away with an embedded headrest assembly in alternative positions;

FIG. 2H is a perspective view of a portion of one embodiment of the embedded headrest assembly;

FIG. 2I is a bottom perspective view of the embedded headrest assembly with a portion of the massage table; and

FIG. 3 is a perspective view of a portion of another embodiment of an embedded headrest assembly usable with the present invention.

### DESCRIPTION

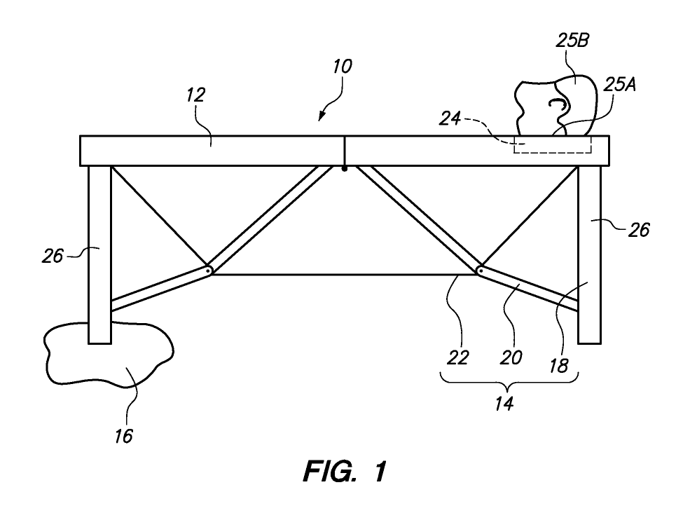

FIG. 1 is a simplified side view of a first embodiment of a massage table 10 having features of the present invention. In this embodiment, the massage table 10 includes (i) a table top assembly 12, (ii) a support assembly 14 that supports the table top assembly 12 above a surface 16 (partly shown in FIG. 1) e.g., a floor, the support assembly 14 having a leg assembly 18, a brace assembly 20 and a cable assembly 22; and (iii) a headrest assembly 24 (illustrated in phantom) that is embedded into the table top assembly 12 and that supports a face 25A and/or a head 25B of the user of the massage table 10. The design of the various components of the massage table 10 can be varied to achieve the desired shape, weight, and strength characteristics of the massage table 10. Alternatively, the massage table 10 can be designed with fewer or more components than that illustrated in FIG. 1. For example, the massage table 10 could be designed without the brace assembly 20 and/or the cable assembly 22 or with a different type of brace assembly 20 and/or cable assembly 22 than that illustrated in FIG. 1.

In certain embodiments that are portable, the massage table 10 is moveable between a working configuration (illustrated in FIG. 1) and a transport configuration (not shown). In the working configuration, the massage table 10 can be set up on the surface 16, and the massage table 10 is ready for supporting a person above the surface 16 for a massage. In the transport configuration, the massage table 10 can be folded and moved relatively easily.

As an overview, in certain embodiments, the headrest assembly 24 provides improved comfort and support to the face 25A and/or the head 25B of a person using the massage table 10. Further, the headrest assembly 24 provides improved adjustability to the user of the massage table 10. Additionally or alternatively, in certain embodiments, the headrest assembly 24 includes one or more resilient assemblies that can better respond to the individual weight and shape of the head 25B and can curve to better “wrap”, “envelop” and/or “cradle” the face 25A. The headrest assembly 24 is described in more detail below.

The table top assembly 12 provides a padded surface for a person to rest on during a massage.

The leg assembly 18 extends between the table top assembly 12 and the surface 16 to maintain the table top assembly 12 positioned above and away from the surface 16. In the embodiment illustrated in FIG. 1, the leg assembly 18 includes four spaced apart legs 26 (two are shown in FIG. 1) that are secured to and cantilever downward from the table top assembly 12. Alternatively, the leg assembly 18 could be designed to have more than four or less than four legs 26. Each of the four legs 26 can be secured to the table top assembly 12 near the outer peripheral portions of the table top assembly 12 so as to effectively support the table top assembly 12 when the massage table 10 is in the working configuration. In certain embodiments, the legs 26 can be pivotally secured to the table top assembly 12 to allow the legs 26 to fold up underneath and inside the table top assembly 12 for easier and more compact portability and storage. In some embodiments, the legs 26 can be adjusted so as to vary the height of the table top assembly 12 relative to the surface 16. Non-exclusive examples of suitable materials for the legs 26 include aluminum, steel, plastic or composite.

The brace assembly 20 extends between the table top assembly 12 and leg assembly 18 to provide additional support to the leg assembly 18 when the massage table 10 is in the working configuration. Further, the brace assembly 20 allows the legs 26 to be easily moved between the transport configuration, and the working configuration illustrated in FIG. 1. In one embodiment, the brace assembly 20 further includes a rigid first leg cross brace (not shown) that is attached to and extends between the legs 26 at a first end of the massage table 10, and a rigid second leg cross brace (not shown) that is attached to and extends between the legs 26 at a second end of the massage table 10. The leg cross braces provide additional support to the legs 26 and facilitate movement of the legs 26 between the positions. Non-exclusive examples of suitable materials for the leg cross braces include wood, plastic, or aluminum. Alternatively, the massage table 10 can be designed without one or both leg cross braces.

As shown in FIG. 1, the cable assembly 22 can include a plurality of cables that extend between the various elements of the massage table 10 to provide additional strength, stability and rigidity to the massage table 10 during operation and while in the working configuration. The cable assembly 22 also allows for easier fold-up and storage of the massage table 10. The features of suitable cable assemblies 22 are described in U.S. Pat. No. 4,833,998 issued to Everett et al. and U.S. Pat. No. 5,009,170 issued to Spehar, the contents of which are incorporated herein by reference.

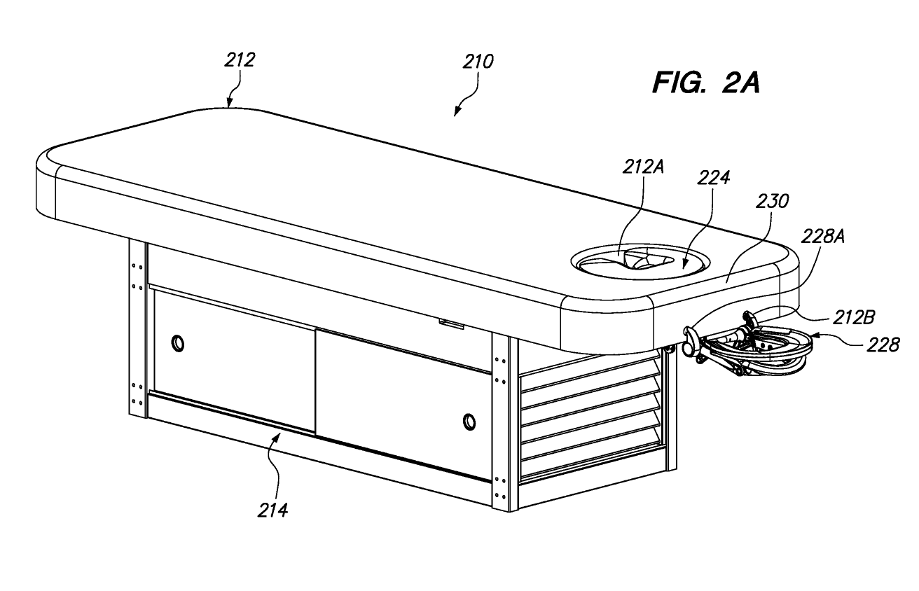

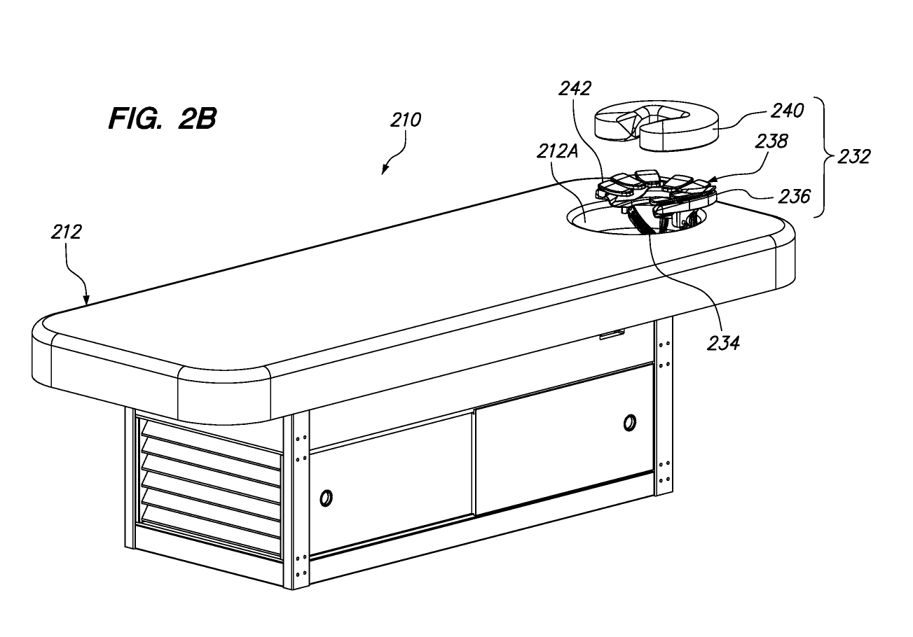

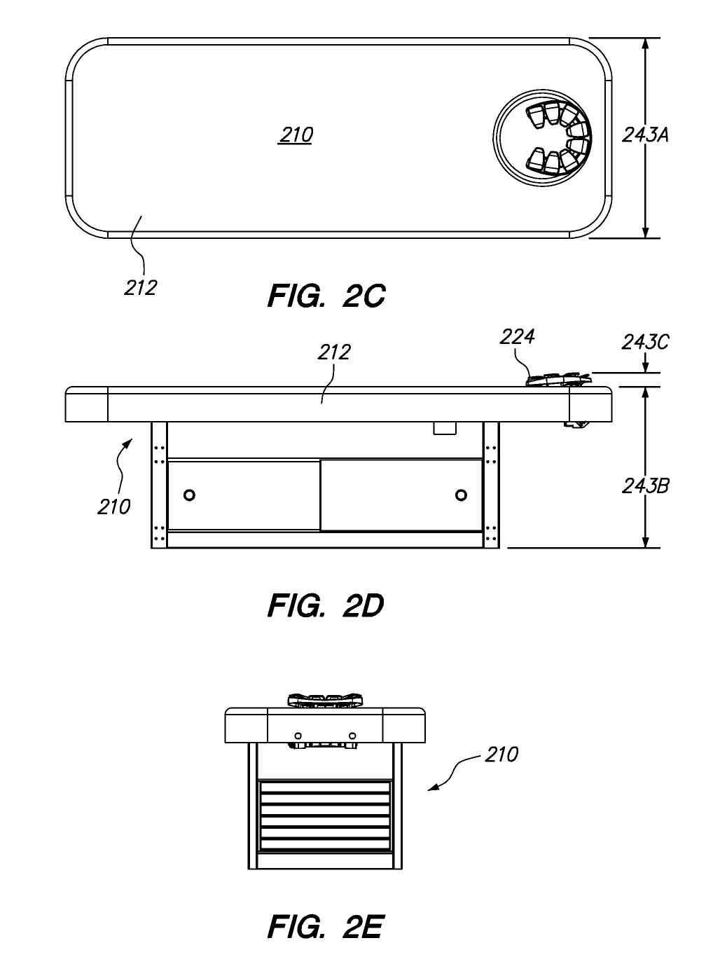

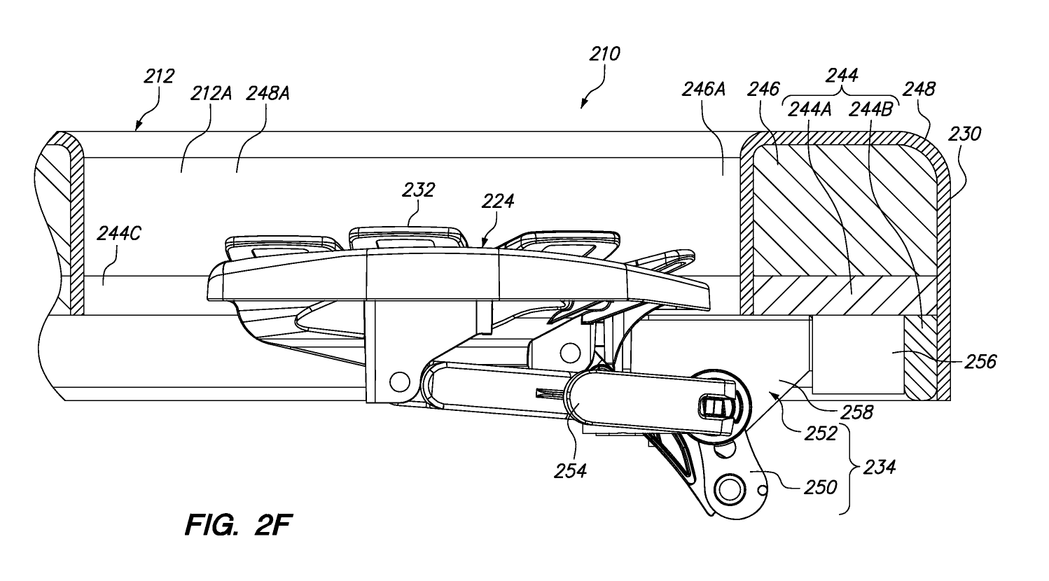

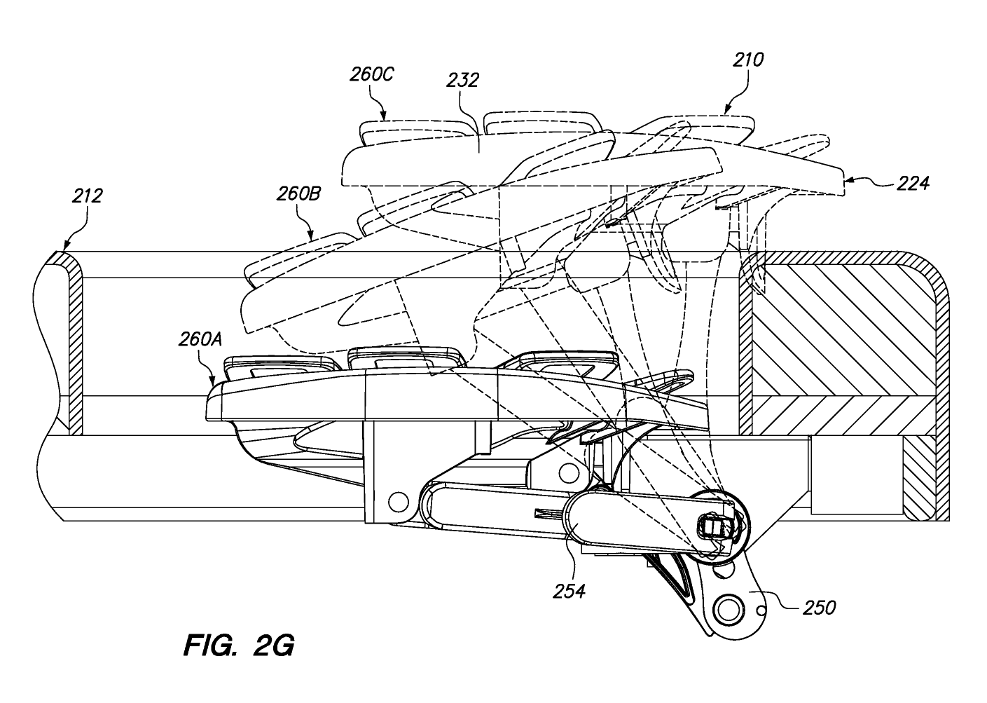

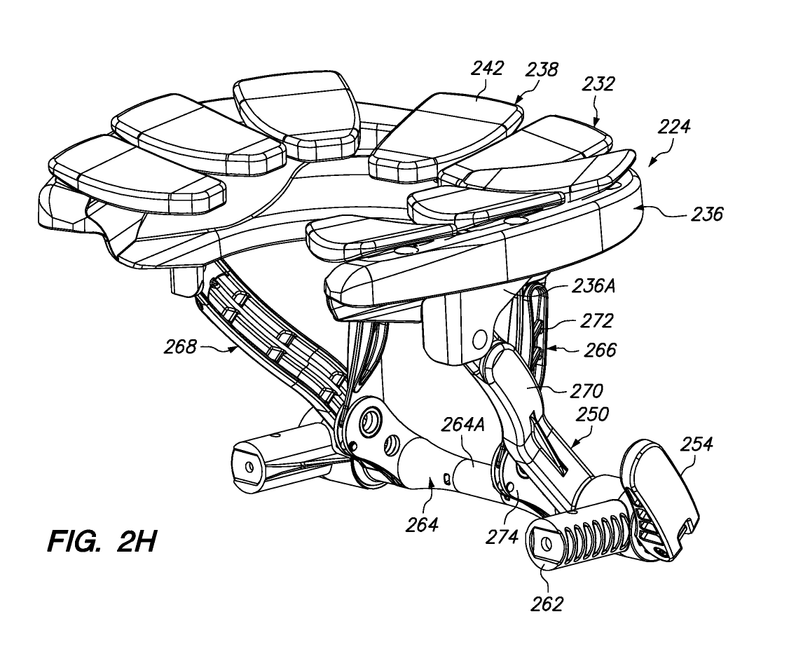

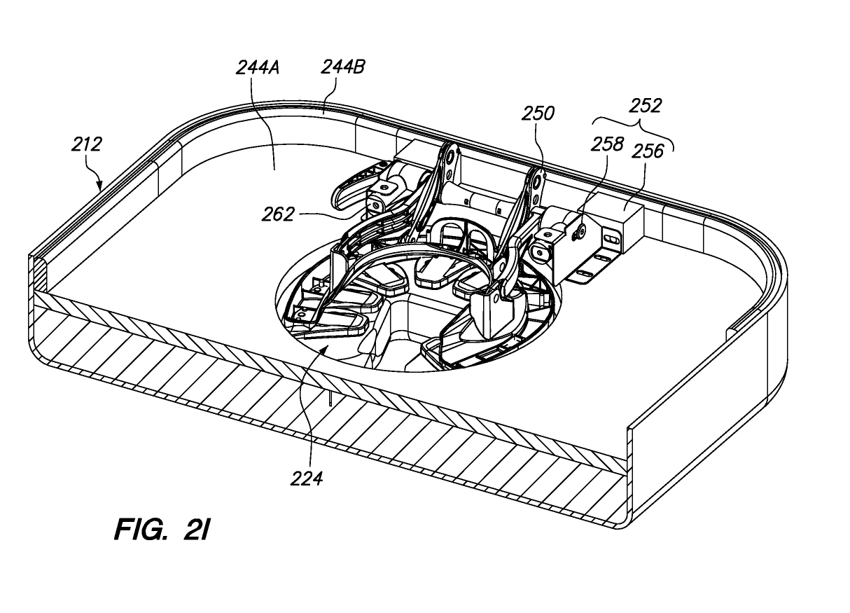

FIG. 2A is a top perspective view of another embodiment of a massage table 210 having features of the present invention. In this embodiment, the massage table 210 is a stationary massage table design that includes (i) a padded table top assembly 212 that supports a person (not shown in FIG. 2A), (ii) a rigid support assembly 214 that supports the table top assembly 212 above the surface 16 (illustrated in FIG. 1), (iii) the embedded headrest assembly 224 that supports the head 25B (illustrated in FIG. 1) of the person, and (iv) an external headrest assembly 228 that alternatively supports the head 25B of the person.

In this embodiment, the table top assembly 212 is generally flat and includes a table aperture 212A that extends through the padded table top assembly 212 near a head end 230 of the table top assembly 212. As provided herein, the table aperture 212A is sufficiently large for a portion of the embedded headrest assembly 224 to be substantially positioned within and encircled by the table top assembly 212.

In FIG. 2A, the table top assembly 212 is generally substantially rectangular shaped. Alternatively, for example, the table top assembly 212 can be another shape, such as an oval shape, an oblong shape, or a rectangular shape with one or more rounded corners.

The embedded headrest assembly 224 and the external headrest assembly 228 can alternatively be used to support the head 25B of the person during a massage. With this design, the positioning of the person or patient on the table top assembly 212 can be chosen to suit the comfort of the patient, the convenience of the person performing the procedure on the patient, and/or the nature of the procedure being performed on the patient. For example, if the patient is using the embedded headrest assembly 224, the majority of the patient is positioned entirely on the table top assembly 212. Alternatively, if the patient is using the external headrest assembly 228, the head 25B (illustrate in FIG. 1) extends past the head end 230 of the table top assembly 212.

In one embodiment, the head end 230 of the table top assembly 212 includes a pair of spaced apart table receivers 212B that are adapted to selectively receive and retain a pair of attachment arms 228A of the external headrest assembly 228 so that a portion of the external headrest assembly 228 extends and cantilevers past the head end 230 of the table top assembly 212. It should be noted that a horse shoe shaped upper resilient foam pad (e.g. a pad or piece of foam enclosed with durable material) of the external headrest assembly 228 is not shown.

FIG. 2B is a top, partly exploded perspective view of the massage table 210 of FIG. 2A. The design of the embedded headrest assembly 224 can be varied to suit the needs of the user of the massage table 210. A couple of non-exclusive designs for the embedded headrest assemblies are discussed herein. For example, FIG. 2B illustrates that the embedded headrest assembly 224 can include a headrest 232 that supports the head 25B (illustrated in FIG. 1) of the person during the massage and a coupler assembly 234 that couples the headrest 232 to the table top assembly 212 or another portion of the massage table 210. FIG. 2B also illustrates that the table aperture 212A extends vertically through the table top assembly 212.

In one embodiment, the headrest 232 includes (i) relatively rigid, generally horseshoe shaped support frame 236 that is secured via the coupler assembly 234 to the massage table 210, (ii) a flexible, lower resilient assembly 238 that is secured to and supported by and above the support frame 236, and (iii) a flexible, upper resilient assembly 240 that is secured to and supported by and above the lower resilient assembly 238. In this embodiment, these components cooperate to adjustably support the head 25B of the patient during the massage.

Some features of the headrest assembly 224 are also described in U.S. patent application Ser. No. 11/452,728, filed on Jun. 13, 2006, and entitled “Headrest Assembly For a Massage Device”, the contents of which are incorporated herein by reference.

In FIG. 2B, the upper resilient assembly 240 is generally horse shoe shaped and can be a piece of foam enclosed with durable material (e.g. leather or nylon). Further, in this embodiment, the upper resilient assembly 240 contacts and supports the face 25A (illustrated in FIG. 1) of the patient.

As provided herein, either of the resilient assemblies 238, 240 can be referred to as the first or second resilient assembly. Further, the upper resilient assembly 240 can also be referred to herein as the upper pad.

In one embodiment, the lower resilient assembly 238 can include a plurality of spaced apart, individual resilient members 242 (e.g. resilient beams) that individually bend, flex, pivot, and cantilever away from the support frame 236. In this embodiment, the resilient members 242 are arranged into a horseshoe configuration and the resilient members 242 can individually flex to conform to the face 25A of the patient.

It should be noted that with the designs provided herein, the resilient assemblies 238, 240 act in series and cooperate to support the face 25A with improved comfort, and the resilient assemblies 238, 240 can better respond to the individual weight and shape of the head 25B and can curve to better “wrap”, “envelop” and/or “cradle” the face 25A. Moreover, the coupler assembly 234 can be used to adjust the position (e.g. height and angle) of the headrest 232 to correspond to the needs of the patient and/or to improve the comfort of the patient.

FIG. 2C is a top view, FIG. 2D is a side view, and FIG. 2E is an end view of a portion of the massage table 210 of FIG. 2A. It should be noted that the external headrest assembly 228 and the upper resilient assembly 240 are not illustrated in FIGS. 2C-2E. Referring to these Figures, in one non-exclusive embodiment (i) the table top assembly 212 can have a width 243A of approximately thirty inches, (ii) the table top assembly 212 can be positioned at a height 243B of approximately twenty-four inches, and (iii) the headrest assembly 224 can be adjusted to an adjustment height 243C of at least approximately four inches above the table top assembly 212.

FIG. 2F is side view of a portion of the massage table 210 of FIG. 2A in partial cut-away. In this embodiment, the table top assembly 212 includes a rigid frame 244, a flexible pad 246, a flexible covering 248, and the table aperture 212A that is defined by or comprises a hole that extends through the frame 244, the pad 246, and the flexible covering 248.

The frame 244 includes a surface portion 244A, a perimeter portion 244B, and a frame aperture 244C. The surface portion 244A is substantially planar and is positioned substantially parallel with the surface 16 (illustrated in FIG. 1). The perimeter portion 244B cantilevers perpendicularly away from the surface portion 244A near the outer edge of the surface portion 244A so that the perimeter portion 244B extends toward the surface 16. The frame 244 is generally rigid and can be made of a rigid material such as wood, aluminum, plastic or other suitable materials. The frame aperture 244C is designed to receive the embedded headrest assembly 224.

The pad 246 provides a cushion for the comfort of the person resting on the massage table 210. The pad 246 includes a pad aperture 246A that is positioned near and end of the pad and corresponds with the frame aperture 244C. Non-exclusive examples of suitable materials for the pad 246 include foam, memory foam, fleece pads, etc.

The covering 248 secures the pad 246 to the frame 244 and provides a protective covering for the pad 246. The covering 248 defines a cover aperture 248A that is positioned near an end of the covering 248 and corresponds with the frame aperture 244C and the pad aperture 246A to form the table aperture 212A. Non-exclusive examples of suitable materials for the covering 248 include leather, plastic, and cloth.

The table aperture 212A is positioned near the head end 230 of the table top assembly 212, is typically circle or oval shaped, and is sized so as to receive at least a portion of the embedded headrest assembly 224. In the present invention, the table aperture 212A is much larger than is typical in previous designs so that the headrest 232 can easily fit and move up and down within the table aperture 212A. Alternatively, the table aperture 212A can have another shape such as rectangular.

A portion of the headrest 232 and the coupler assembly 234 of the embedded headrest assembly 224 are also illustrated in FIG. 2F. In this embodiment, the coupler assembly 234 includes (i) an adjuster assembly 250 that selectively adjusts the height and angle of the headrest 232 relative to the table top assembly 212, and (ii) a bracket assembly 252 that secures and couples the adjuster assembly 250 and the headrest 232 to the table top assembly 212.

In this embodiment, the adjuster assembly 250 includes a locking mechanism 254 that can be selectively moved (e.g. flipped) to selectively lock and unlock the adjuster assembly 250. With this design, (i) with the locking mechanism 254 unlocked, the height and angle of the headrest 232 can be easily and precisely manually adjusted to suit the needs and/or comfort of the person receiving the massage, and (ii) with the locking mechanism 254 locked, the height and angle of the headrest 232 can be fixedly maintained in the desired location.

Further, in this embodiment, the bracket assembly 252 includes a pair of spaced apart retainer blocks 256 (only one is illustrated in FIG. 2F) that are fixedly secured to the frame 244, and a pair of spaced apart retainer brackets 258 (only one is illustrated in FIG. 2F) that are fixedly secured to the retainer blocks 256 and that couple the adjuster assembly 250 to retainer blocks 256.

FIG. 2G is side view of a portion of the massage table 210 of FIG. 2A in partial cut-away with a portion of embedded headrest assembly 224 in three alternative positions 260A-260C (two of which are illustrated in phantom). With the designs provided herein, the locking mechanism 254 can be used to selectively lock and unlock the adjuster assembly 250 so that the angle and height of the headrest 232 can be adjusted to a plurality of different positions 260A-260C relative to the table top assembly 212. It should be noted that the number of different positions can be much greater than the three positions 260A-260C illustrated in FIG. 2G. Further, the positions vary from the headrest 232 being completely above the upper surface of the table top assembly 212, to the headrest 232 being partially above the upper surface of the table top assembly 212, to the headrest 232 being completely below the upper surface of the table top assembly 212.

FIG. 2H is a perspective view of the embedded headrest assembly 224 described above without the upper resilient assembly 240 (illustrated in FIG. 2B). In FIG. 2H, the support frame 236, and the resilient members 242 of the lower resilient assembly 238 are clearly illustrated. In this embodiment, the lower resilient assembly 238 includes eight spaced apart resilient members 242. Further, in this embodiment, the support frame 236 includes four spaced apart frame flanges 236A (only three are visible in FIG. 2H) that extend downward and that are used to pivotably attach the adjuster assembly 250 to the support frame 236.

The adjuster assembly 250 allows for the adjustment of the position of the headrest 232. The design of the adjuster assembly 250 can be varied to achieve the desired range and type of adjustment of the position of the headrest 232. In one non-exclusive embodiment, the adjuster assembly 250 includes (i) a pair of spaced apart attachment arms 262 that are secured via the bracket assembly 252 (illustrated in FIG. 2F) to the frame 244 (illustrated in FIG. 2F), (ii) an adjuster connector 264 that extends between and couples together the attachment arms 262 and the other components, (iii) a first adjuster subassembly 266 that extends between the adjuster connector 264 and the support frame 236, (iv) a spaced apart second adjuster subassembly 268 that extends between the adjuster connector 264 and the support frame 236, and (v) the locking mechanism 254 that selectively locks and unlocks the adjuster connector 264.

In one embodiment, the adjuster connector 264 includes (i) a rod (not shown) that extends through the attachment arms 262 and the adjuster subassemblies 266, 268, and (ii) spacers 264A that maintain the adjuster subassemblies 266, 268 and the attachment arms 262 properly spaced apart. In one non-exclusive embodiment, the locking mechanism 254 can be a flip latch that is attached to one end of the rod. With this design, (i) the flip latch can be selectively pushed down to pull the adjuster subassemblies 266, 268 and the attachment arms 262 together to inhibit movement and lock the headrest 232 in position, or (ii) the flip latch can be selectively rotated up to allow the adjuster subassemblies 266, 268 and the attachment arms 262 to separate along the rod and thus allow for relative rotation between the adjuster subassemblies 266, 268 and the attachment arms 262 about the adjuster connector 264 to adjust of the position of the headrest 232. It should be noted that one or more of the areas of contact of the adjuster subassemblies 266, 268 and the attachment arms 262 can include teeth that engage when the locking mechanism 254 is locked to inhibit relative rotation.

The design of each of the adjuster subassemblies 266, 268 can be varied to achieve the adjustment requirements of the headrest 232. In FIG. 2H, each of the adjuster subassemblies 266, 268 includes a first bar 270, a second bar 272, and a third bar 274, and each bar 270, 272, 274 includes a first end and an opposed second end. For each adjuster subassembly 266, 268, (i) the first end of the first bar 270 is pivotably connected to the adjuster connector 264, and the second end of the first bar 270 is pivotably connected to the support frame 236; (ii) the first end of the second bar 272 is pivotably connected to the third bar 274, and the second end of the second bar 272 is pivotably connected to the support frame 236; and (iii) the first end of the third bar 274 is pivotably connected to the adjuster connector 264, and the second end of the third bar 274 is pivotably connected to the second bar 272. With this design, the three bars 270, 272, 274 of each adjuster subassembly 266, 268 cooperate with the support frame 236 to form a four bar type linkage arrangement.

FIG. 2I is a bottom perspective view of the embedded headrest assembly 224 with a portion of the table top assembly 212. This Figure illustrates how the bracket assembly 252 attaches the adjuster assembly 250 to the bottom of the table top assembly 212. More specifically, FIG. 2I illustrates the pair of spaced apart retainer blocks 256 and the pair of retainer brackets 258. In this embodiment, (i) the retainer blocks 256 are spaced apart and are fixedly attached to the bottom of the surface portion 244A and the perimeter portion 244B, and (ii) each of the retainer brackets 258 are fixedly secured to one of the retainer blocks 256. Further, each of the retainer brackets 258 securely retains one of the attachment arms 262 of the adjuster assembly 250.

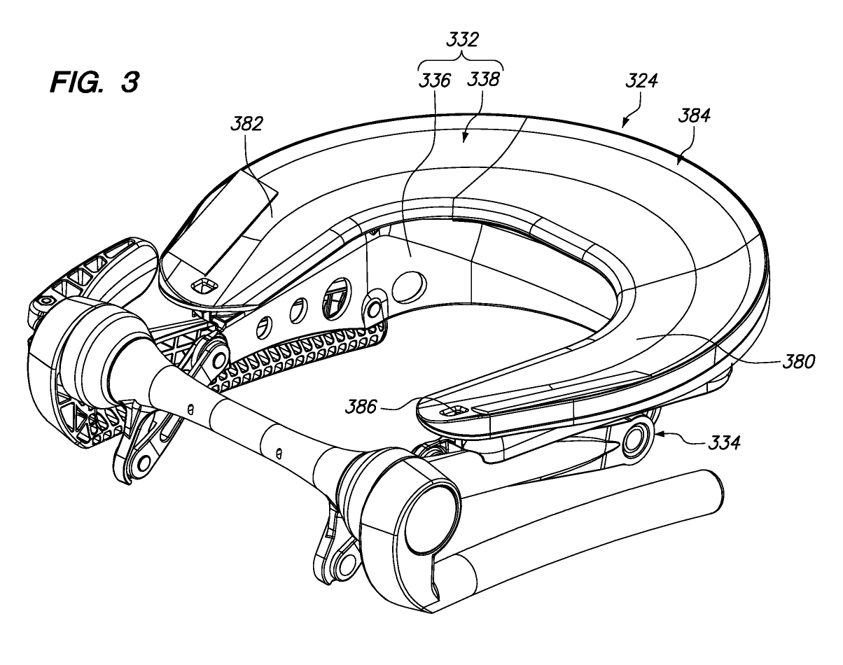

FIG. 3 is a perspective view of a portion of another embodiment of an embedded headrest assembly 324 that can be used as the embedded headrest assembly or the external headrest assembly in the massage tables 10, 210 illustrated in FIGS. 1 and 2A. In this embodiment, the headrest assembly 324 again includes a headrest 332 that supports the head 25B (illustrated in FIG. 1) of the person during the massage and a coupler assembly 334 that couples the headrest 332 to the massage table 210 (illustrated in FIG. 2A).

In this embodiment, the headrest 332 includes (i) relatively rigid, generally horseshoe shaped support frame 336 that is secured via the coupler assembly 334 to the massage table 210, (ii) a flexible, lower resilient assembly 338 that is secured to and supported by and above the support frame 336, and (iii) a flexible, upper resilient assembly 240 (illustrated in FIG. 2B) or upper pad that is secured to and supported by and above the lower resilient assembly 338. In this embodiment, these components cooperate to adjustably support the head 25B of the person during the massage. These components are also in U.S. patent application Ser. No. 12/237,031, filed on Sep. 24, 2008, and entitled Headrest Assembly For a Massage Device”, the contents of which are incorporated herein by reference.

In FIG. 3, the lower resilient assembly 338 is a headrest platform that supports the upper resilient member 240, the headrest platform having (i) a first side section 380, (ii) a second side section 382, (iii) a middle section 384 that is positioned substantially between and is coupled to the first side section 380 and the second side section 382, and (iv) a hinge assembly 386 that pivotably connects the sections 380, 382, 384 to the support frame 336 and that allows the middle section 384 to flex downward and the side sections 380, 382 to pivot upward and inward toward each other when downward pressure is applied on the middle section 384. In this embodiment, when the face 25A (illustrated in FIG. 1) of the user is positioned within the headrest platform 338, the side sections 380, 382 are designed to support the cheeks of the user, while the middle section 384 is designed to support the forehead of the user.

The first side section 380 and the second side section 382 can each be made with a substantially rigid, plastic material. The middle section 384 can be made with a softer, flexible rubber material. Alternatively, the side sections 380, 382 can be made with a different, substantially rigid material and the middle section 384 can be made with a different flexible material.

The headrest platform 338 is supported on the surface with the hinge assembly 386 that allows the middle section 384 to flex when weight is applied. Additionally, the inside edge of the horseshoe shape of the headrest platform 338 may also be designed to flex when a load is applied. Further, when load is applied to the headrest platform 338 and the middle section 384 flexes downward, the hinge assembly 386 causes the side sections 380, 382 to pivot upward and inward toward each other. When the load is removed from the headrest platform 338, the headrest platform 338 will elastically recover from all the deformation.

In one embodiment, when a load is applied to the headrest platform 338, the middle section 384, which is made of a softer, rubber material, flexes downward, while the side sections 380, 382, which are made of a rigid, plastic material, pivot upward and inward toward each other to respond to the individual weight and shape of the head by “wrapping”, “enveloping” and/or “cradling” the face and/or the head of the user.

While the current invention is disclosed in detail herein, it is to be understood that it is merely illustrative of the presently preferred embodiments of the invention and that no limitations are intended to the details of construction or design herein shown other than as described in the appended claims.

What is claimed is:

1. A massage table for supporting a person above a surface during a massage, the massage table comprising:
a table top assembly including a table aperture; and
a headrest assembly that is positioned substantially within the table aperture, the headrest assembly including a headrest that supports a head of the person during the massage and a coupler assembly that couples the headrest to the table top assembly.

2. The massage table of claim 1 wherein the headrest includes a support frame and a resilient assembly that is positioned substantially above the support frame and is supported by the support frame, the support frame and the resilient assembly cooperating to adjustably support the head of the person during the massage.

3. The massage table of claim 2 wherein the coupler assembly includes an adjuster assembly that selectively adjusts the height and angle of the headrest relative to the table top assembly.

4. The massage table of claim 3 wherein the coupler assembly further includes a bracket assembly that couples the adjuster assembly to the table top assembly.

5. The massage table of claim 2 wherein the headrest further includes an upper pad that is positioned substantially above the resilient assembly and is supported by the resilient assembly.

6. The massage table of claim 2 wherein the resilient assembly includes an upper resilient member and a headrest platform that supports the upper resilient member, the headrest platform having a first side section, a second side section, a middle section that is positioned substantially between and is coupled to the first side section and the second side section, and a hinge assembly that allows the middle section to flex downward and the side sections to pivot upward and inward toward each other when downward pressure is applied on the middle section.

7. The massage table of claim 2 wherein the resilient assembly includes a first resilient subassembly that is coupled to the support frame, and a second resilient subassembly that engages the first resilient subassembly, the first resilient subassembly and the second resilient subassembly cooperating to support the head of the person during the massage.

8. The massage table of claim 7 wherein the first resilient subassembly includes a resilient member that extends away from the support frame and the second resilient subassembly engages the resilient member.

9. A massage table for supporting a person above a surface during a massage, the massage table comprising:
a table top assembly including a table aperture; and
a headrest assembly that is positioned substantially within the table aperture, the headrest assembly including a headrest and a coupler assembly that couples the headrest to the table top assembly, the headrest having a support frame, a resilient assembly that is coupled to the support frame and is supported by the support frame, and an upper pad that is positioned substantially above the resilient assembly and is supported by the resilient assembly, and the coupler assembly including an adjuster assembly that selectively adjusts the height and angle of the headrest relative to the table top assembly to adjustably support a head of the person during the massage.

10. The massage table of claim 9 wherein the coupler assembly includes a first bracket that is secured to the table top assembly, and a spaced apart second bracket that is secured to the table top assembly.

11. The massage table of claim 9 wherein the resilient assembly includes a headrest platform having a first side section, a second side section, a middle section that is positioned substantially between and is coupled to the first side section and the second side section, and a hinge assembly that allows the middle section to flex downward and the side sections to pivot upward and inward toward each other when downward pressure is applied on the middle section.

12. A method for supporting a person above a surface during a massage, the method comprising the steps of:
providing a table top assembly including a table aperture;
positioning a headrest substantially within the table aperture;
coupling the headrest to the table top assembly with a coupler assembly; and
supporting a head of the person during the massage with the headrest.

13. The method of claim 12 wherein the step of positioning includes the steps of positioning a support frame substantially within the table aperture, positioning a resilient assembly substantially above the support frame, and supporting the resilient assembly with the support frame.

14. The method of claim 12 further comprising the step of selectively adjusting the height and angle of the headrest relative to the table top assembly with an adjuster assembly.

14. The method of claim 12 wherein the step of positioning the headrest includes the headrest having a resilient member and a headrest platform that supports the upper resilient member, the headrest platform having a first side section, a second side section, a middle section that is positioned substantially between and is coupled to the first side section and the second side section, and a hinge assembly that allows the middle section to flex downward and the side sections to pivot upward and inward toward each other when downward pressure is applied on the middle section.

15. The method of claim 12 wherein the step of positioning the headrest includes the headrest having a support frame, a first resilient subassembly that is coupled to the support frame, and a second resilient subassembly that engages the first resilient subassembly, the first resilient subassembly and the second resilient subassembly cooperating to support the head of the person during the massage.
